(19) United States
(12) Patent Application Publication
(10) Pub. No.: US 2013/0200018 A1
(43) Pub. Date: Aug. 8, 2013

(54) BALLASTED ROOF AND GROUND MOUNTED SOLAR PANEL RACKING SYSTEM

(71) Applicants: David B.P. Lewenz, St. Petersburg, FL (US); Michael Joseph Molder, Wilmington, DE (US)

(72) Inventors: David B.P. Lewenz, St. Petersburg, FL (US); Michael Joseph Molder, Wilmington, DE (US)

(21) Appl. No.: 13/523,884

(22) Filed: Jun. 15, 2012

Related U.S. Application Data
(63) Continuation-in-part of application No. 13/365,168, filed on Feb. 2, 2012.

(51) Int. Cl. F24J 2/52; B23P 11/00

(52) U.S. Cl. 211/41.18; 29/428

(57) ABSTRACT

A light weight ballasted solar racking system has light ballasted weight loads and is easy and fast to install. The racking system may be used in roof or ground mount applications to mount thin film and frameless solar modules. The racking system physically attaches to the solar panel at the manufactured mounting holes with a set of struts that then attach to a ballast tray that holds the system in place. A set of struts may determine the degree of angle from about 5 to about 35 degrees, for example. The front of the ballast tray has an air pass way of about 3-5 inches, while the back of the system has about 8-12 inches of space for an air pass way. Multiple racking systems may be linked together, resulting in the need for less ballast weight for each racking system.

### CROSS-REFERENCE TO RELATED APPLICATIONS

This application is a continuation-in-part of U.S. patent application Ser. No. 13/365,168, filed Feb. 2, 2012, the contents of which are herein incorporated by reference.

### BACKGROUND OF THE INVENTION

The present invention relates to solar panel racking systems and, more particularly, to a ballasted roof or ground mounted solar panel racking system.

Conventional solar panel racking systems attach directly to the roof or use a concrete curb system that sits on the roof and can potentially damage the roof surface. These conventional mounting systems are often time consuming to build and install, often resulting in leaks in the roof surface overtime.

As can be seen, there is a need for an improved solar panel racking system.

### SUMMARY OF THE INVENTION

In one aspect of the present invention, a racking system for a solar panel comprises a ballast pan having a base and first and second side extending from each side of the base; a mounting strut extending along the first side of the ballast pan, running at an angle relative to the base of the ballast pan, and extending along the second side of the ballast pan; and one or more ballast blocks disposed on the ballast pan.

In another aspect of the present invention, a racking system for a solar panel comprises a ballast pan having a base and first and second side extending from each side of the base; a mounting strut extending along the first side of the ballast pan, running at an angle relative to the base of the ballast pan, and extending along the second side of the ballast pan; one or more ballast blocks disposed on the ballast pan; a foam board disposed under the ballast pan; and a solar module attachment fastener adapted to connect the mounting strut to a solar module.

In a further aspect of the present invention, a method for mounting a solar module on a surface comprises disposing a ballast pan, having a base and first and second side extending from each side of the base, on the surface; extending a mounting strut along the first side of the ballast pan, running at an angle relative to the base of the ballast pan, and extending along the second side of the ballast pan; securing the mounting strut to the first and second sides of the ballast pan; placing one or more ballast blocks on the ballast pan; and attaching the solar module to the mounting strut.

These and other features, aspects and advantages of the present invention will become better understood with reference to the following drawings, description and claims.

### BRIEF DESCRIPTION OF THE DRAWINGS

FIG. 1 is a perspective view of a racking system, in use to mount a solar panel, according to an exemplary embodiment of the present invention;

FIG. 2 is a cross-sectional view taken along line 2-2 of FIG. 1;

FIG. 3 is a side view of the racking system of FIG. 1 in a first angled configuration;

FIG. 4 is a cross-sectional view taken along line 4-4 of FIG. 1;

FIG. 5 is a close-up view of a solar panel attachment fastener according to an exemplary embodiment of the present invention;

FIG. 6 is a side view of the racking system of FIG. 1 in a second angled configuration;

FIG. 7 is a side view of the racking system of FIG. 1 in a third angled configuration;

FIG. 8 is a side view of the racking system of FIG. 1 in a fourth angled configuration;

FIG. 9 is a side view of the racking system of FIG. 1 in a fifth angled configuration;

FIG. 10 is a side view of the racking system of FIG. 1 in a sixth angled configuration;

FIG. 11 is a perspective view of an interconnection bar used to connect adjacent racking systems together;

FIG. 12 is a cross-sectional view taken along line 12-12 of FIG. 11;

FIG. 13 is a side view of two racking systems connected together according to an exemplary embodiment of the present invention; and

FIG. 14 is a side view of a racking system for mounting frameless solar modules according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a light weight ballasted solar racking system that has light ballasted weight loads and is easy and fast to install. The racking system of the present invention may be used in roof or ground mount applications to mount thin film and frameless solar modules. The racking system physically attaches to the solar panel at the manufactured mounting holes with a set of struts that then attach to a ballast tray that holds the system in place. A set of struts may determine the degree of angle from about 5 to about 35 degrees, for example. The front of the ballast tray has an air pass way of about 3-5 inches, while the back of the system has about 8-12 inches of space for an air pass way. Multiple racking systems may be linked together, resulting in the need for less ballast weight for each racking system.

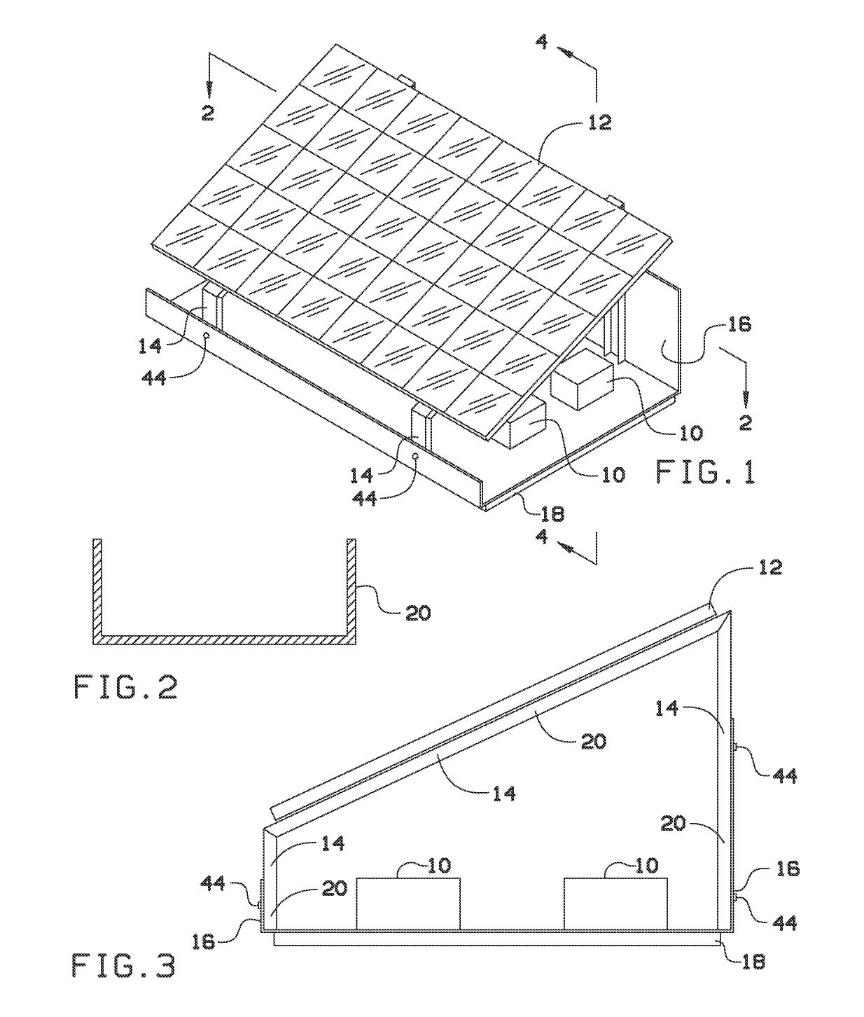

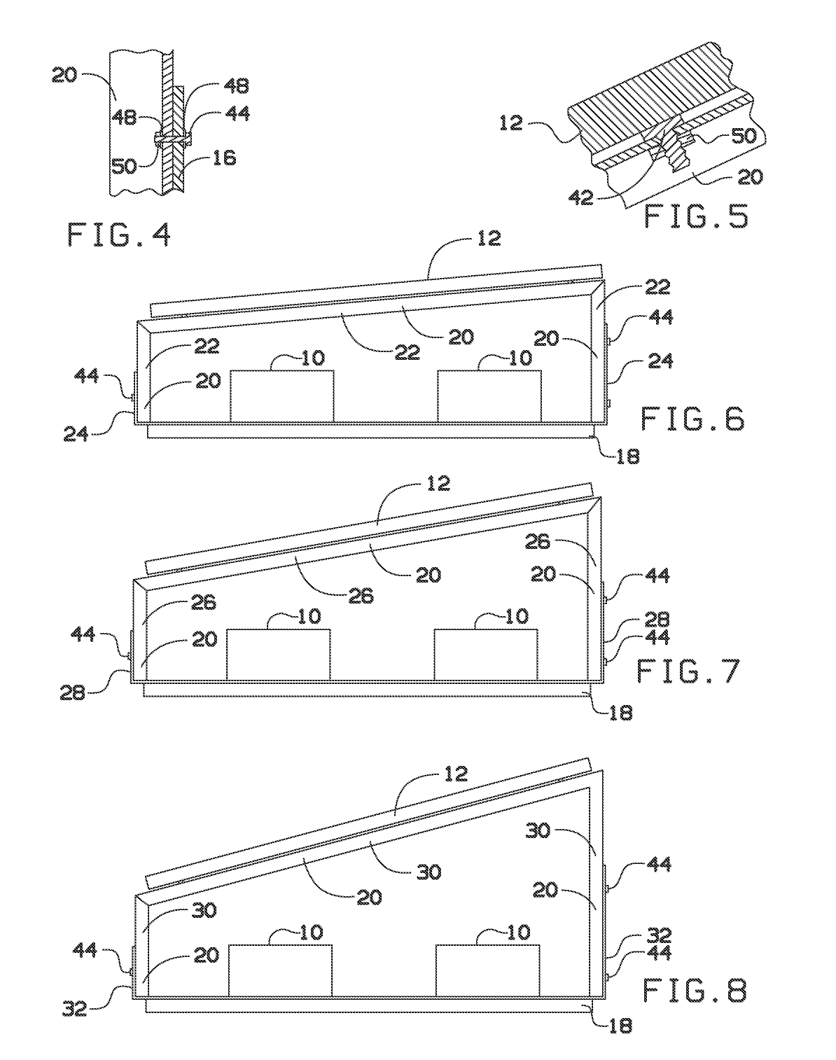

Referring now to FIGS. 1 through 5, a racking system may include a ballast pan 16 shaped in a U-shape, where the base of the U-shape is adapted to rest on a roof of on the ground, for example. A front side of the U-shape may be shorter than a back side of the U-shape. The base of the ballast pan 16 may be adapted to hold one or more ballast blocks 10.

The ballast pan 16 may be fabricated from aluminum, although other materials, such as steel, stainless steel, and plastic, may be used. The ballast pan 16 may be made in various thicknesses. For an aluminum ballast pan, for example, 0.063 gauge aluminum may be used. The ballast pan 16 may be fabricated from a flat piece of material that is sheared to size and bent to shape. The sides of the ballast pan 16 may extend generally perpendicular from the base of the ballast pan 16. The footprint of the ballast pan 16 may be the same or larger than the footprint of a solar panel 12 mounted on the racking system.

The ballast pan 16 may include a hat channel, for example, bent from the same material and attached to the bottom to accommodate installations on the ground. Hat channels can be fabricated in varying heights, depending on system mounting concerns.

A foam board 18 may be disposed on the bottom of the ballast pan 16 to separate the metal ballast pan 16 from roofing material. The foam board 18 may also promote proper water drainage of the racking system when installed on roofs. The foam board 18 can be utilized in varying thickness, rigidity, and resiliency to accommodate different roof concerns.

A mounting strut 14 may extend generally perpendicular from the base of the ballast pan 16 at one side of the ballast pan 16, may be bent at an appropriate angle (relative to the roof) and may be further bent to extend to the other side of the ballast pan 16, again meeting the ballast pan in a generally perpendicular fashion. The mounting strut may be attached to the ballast pan 16 by using a bolt 44, nut 50 and star washer 48. Other attachment mechanisms, such as sheet metal screws, may be used in place of the nut 50 and bolt 44.

The mounting strut 14 may be made of the same material as the ballast pan 16. In some embodiments, the mounting strut 14 may be a material different from the material of the ballast pan 16. The mounting strut 14 may be made from flat sheets of aluminum, for example. The sheets may be punched, notched and bent to the proper angle and size. The final bends which determine the solar module mounting angle may be mechanically secured with a sleet metal screw or rivet, or may be welded to maintain the structural integrity.

From one to four, or more, mounting struts 14 may be used on each racking system. As shown in FIG. 1, two mounting struts 14 may be used.

The mounting strut 14 may contain two punched holes which align with the solar module manufacturer supplied frame mounting holes to secure the struts 14 to the solar module 12 using four solar module attachment fasteners 42, for example. Other mechanisms may be used to attach the solar module 12 to the mounting struts 14.

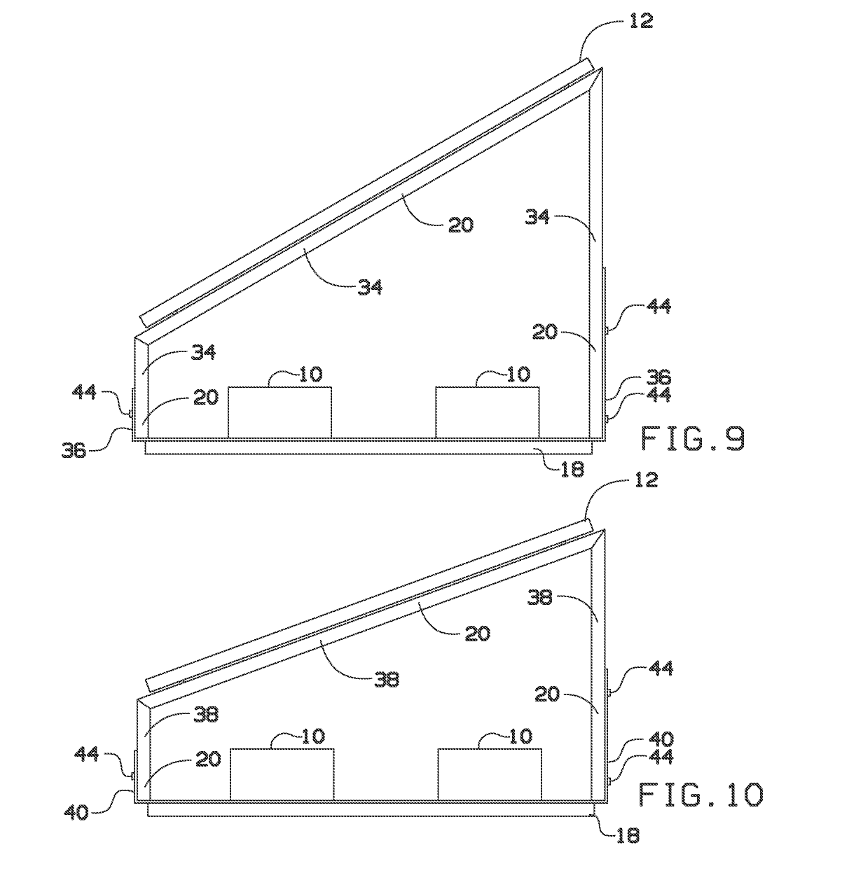

The struts 14 and ballast pan 16 may be designed, for example, to provide an angle of about 25 degrees relative to the mounting surface (such as the ground or a roof). Referring to FIG. 6, a 5 degree mounting strut 22 and a 5 degree ballast pan 24 may provide a 5 degree angle for the solar module 12. Referring to FIG. 7, a 10 degree mounting strut 26 and a 10 degree ballast pan 28 may provide a 10 degree angle for the solar module 12. Referring to FIG. 8, a 15 degree mounting strut 30 and a 15 degree ballast pan 32 may provide a 15 degree angle for the solar module 12. Referring to FIG. 9, a 20 degree mounting strut 34 and a 20 degree ballast pan 36 may provide a 20 degree angle for the solar module 12. Referring to FIG. 10, a 30 degree mounting strut 38 and a 30 degree ballast pan 40 may provide a 30 degree angle for the solar module 12. Other angles may be envisioned within the scope of the present invention by changing the sizes of the struts and ballast pan. In some embodiments, the same size and shape ballast pan may be used with different sized struts to vary the angle of the solar module 12.

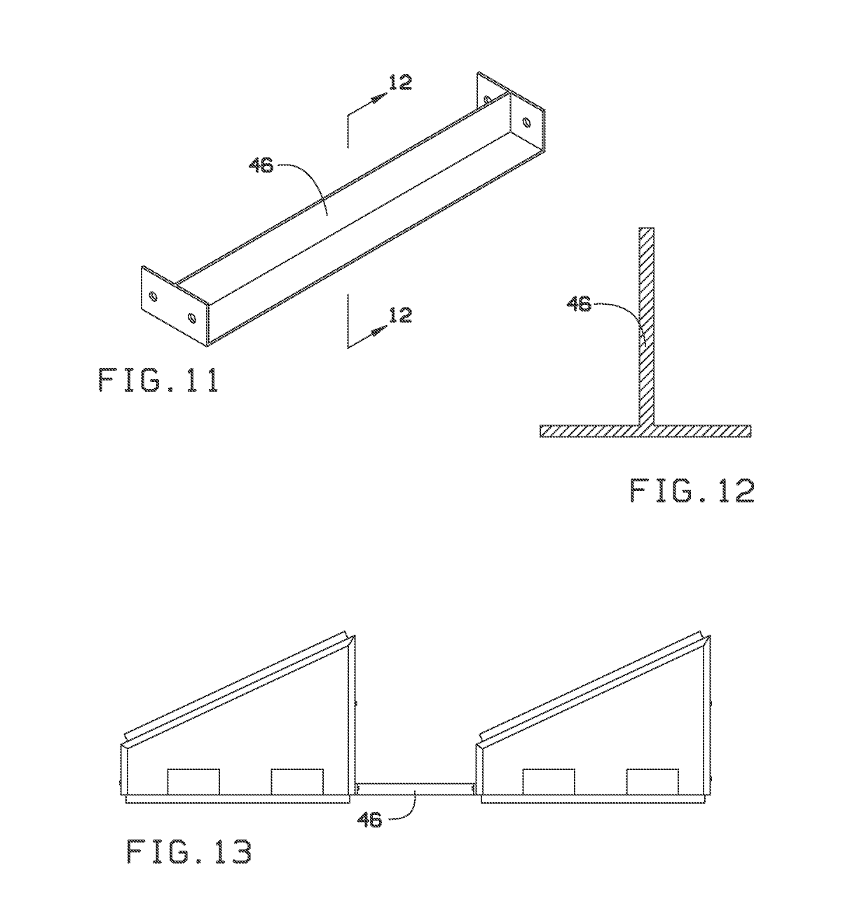

Referring now to FIGS. 11 through 13, multiple racking systems may be interconnected with one or more interconnection bars 46. The interconnection bars 46 may be L-shaped or T-shaped, for example. The interconnection bars 46 may be made of various lengths and may be installed in the space between the rows of ballast pans, connecting one ballast pan to a ballast pan in an adjacent row. The interconnection bars 46 may also be used to join racking systems side-by-side. Various connection mechanisms may be used to attach the interconnection bars 46 to the ballast pans.

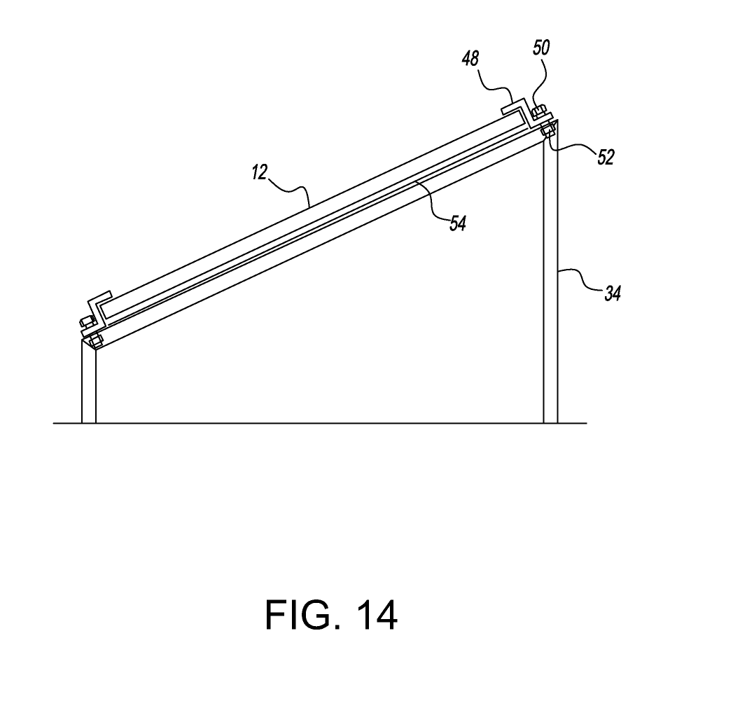

Referring now to FIG. 14, the solar module 12 may be a frameless solar module. A protective padding, such as an adhesive foam tape 54 may be disposed on top of the mounting strut 34 to protect the solar module 12 against the mounting strut 34. The retaining clips 48 may be secured to the mounting strut 34 on a first end thereof and may be adapted to overlap a portion an edge of the solar module 12. A retention system may be used to secure the retaining clips 48 to the mounting strut 34. The retention system may include various fastening methods, such as clamping the retaining clip 48 to the mounting strut 34 with a bolt 50, nut 52 and optional washers. In some embodiments, the retention system may include a self-tapping screw or a push-in clip that locks into the strut with a strike plate or grounding plate, for example. Other fastening means may be contemplated for the retention system and are included within the scope of the present invention. The ballast blocks 10, ballast pan 16, and foam pad 18 may be included, as described above, with the system shown in FIG. 14.

Proper electrical ground may be provided for the racking systems of the present invention. For example, a grounding washers and grounding clips may be used to provide a continuous grounding path for each or multiple rows of ballast pans. Other electrical grounding mechanisms may be used to comply with national or local electric codes.

It should be understood, of course, that the foregoing relates to exemplary embodiments of the invention and that modifications may be made without departing from the spirit and scope of the invention as set forth in the following claims.

What is claimed is:

1. A racking system for a solar panel comprising:
a ballast pan having a base and first and second sides extending from opposite ends of the base, wherein the second side extends higher than the first side;
a mounting strut having a first section extending along the first side of the ballast pan such that the first side of the ballast pan extends along at least a quarter of the length of the first section of the strut, a second section running at an angle relative to the base of the ballast pan, and a third section extending along the second side of the ballast pan such that the second side of the ballast pan extends along at least a quarter of the length of the third section of the strut, wherein a first gap is defined between an end of the first side of the ballast pan and the second section of the strut and a second gap is defined between an end of the second side of the ballast pan and the second section of the strut;
one or more ballast blocks disposed on the ballast pan; and
wherein the solar panel is a frameless solar panel secured to the mounting strut with a plurality of retaining clips.

2. The racking system of claim 1, further comprising a foam board disposed under the ballast pan.

3. The racking system of claim 1, further comprising a solar module attachment fastener adapted to connect the mounting strut to a solar module.

4. The racking system of claim 1, further comprising an interconnection bar attached to the ballast pan of a first racking system and the ballast pan of a second, adjacent racking system.

5. The racking system of claim 1, wherein the angle is from about 5 degrees to about 35 degrees.

6. (canceled)

7. The racking system of claim 1, wherein the plurality of retaining clips are secured to the mounting strut at a first end thereof with a retention system and the second end of the retaining clips extend over an edge of the solar panel.

8. A racking system for a solar panel comprising:
a ballast pan having a base and first and second sides extending from opposite ends of the base, wherein the second side extends higher than the first side;
a mounting strut having a first section extending along the first side of the ballast pan such that the first side of the ballast pan extends along at least a quarter of the length of the first section of the strut, a second section running at an angle relative to the base of the ballast pan, and a third section extending along the second side of the ballast pan such that the second side of the ballast pan extends along at least a quarter of the length of the third section of the strut, wherein a first gap is defined between an end of the first side of the ballast pan and the second section of the strut and a second gap is defined between an end of the second side of the ballast pan and the second section of the strut;
one or more ballast blocks disposed on the ballast pan;
a foam board disposed under the ballast pan; and
wherein the solar panel is a frameless solar panel secured to the mounting strut with a plurality of retaining clips.

9. The racking system of claim 8, further comprising an interconnection bar attached to the ballast pan of a first racking system and the ballast pan of a second, adjacent racking system.

10. The racking system of claim 8, wherein the angle is from about 5 degrees to about 35 degrees.

11. A method for mounting a solar module on a surface, the method comprising:
disposing a ballast pan on the surface, the ballast pan having a base and first and second sides extending from opposite ends of the base, wherein the second side extends higher than the first side;
providing a mounting strut having a first section extending along the first side of the ballast pan such that the first side of the ballast pan extends along at least a quarter of the length of the first section of the strut, a second section running at an angle relative to the base of the ballast pan, and a third section extending along the second side of the ballast pan such that the second side of the ballast pan extends along at least a quarter of the length of the third section of the strut, wherein a first gap is defined between an end of the first side of the ballast pan and the second section of the strut and a second gap is defined between an end of the second side of the ballast pan and the second section of the strut;
securing the mounting strut to the first and second sides of the ballast pan;
placing one or more ballast blocks on the ballast pan; and
attaching the solar module to the mounting strut with a plurality of retaining clips.

12. The method of claim 11, further comprising adjusting the size of the mounting strut such that a predetermined angle, with respect to the ballast base, is formed to mount the solar module thereupon.
